(19) United States
(12) Patent Application Publication
(10) Pub. No.: US 2005/0216900 A1
(43) Pub. Date: Sep. 29, 2005

(54) Instruction scheduling

(76) Inventors: Xiaohua Shi, Beijing (CN); Bu Qi Cheng, Beijing (CN); Guei-Yuan Lueh, San Jose, CA (US)

Correspondence Address: TROP PRUNER & HU, PC, 8554 KATY FREEWAY, SUITE 100, HOUSTON, TX, 77024, US

(21) Appl. No.: 10/812,373

(22) Filed: Mar. 29, 2004

(51) Int. Cl. G06F 9/45

(52) U.S. Cl. 717/161

(57) ABSTRACT

A technique includes providing a virtual machine for instruction scheduling by extending a register scoreboard. A system assigns a number of stall cycles between a first and a second instruction and schedules the first and second instructions for execution based on the assigned stall cycles.

### BACKGROUND

This invention relates generally to instruction scheduling, and more particularly to scheduling instructions in execution environments for programs written for virtual machines.

One of the factors preventing designers of processors from improving performance is the interdependencies between instructions. Instructions are considered to be data dependent if the first produces a result that is used by the second, or if the second instruction is data dependent on the first through a third instruction. Dependent instructions cannot be executed in parallel because one cannot change the execution sequence of dependent instructions. Traditionally, register allocation and instruction scheduling are performed independently with one process before the other during code generation. There is little communication between the two processes. Register allocation focuses on minimizing the amount of loads and stores, while instruction scheduling focuses on maximizing parallel instruction execution.

A compiler translates programming languages in executable code. A modem compiler is often organized into many phases, each operating on a different abstract language. For example, JAVA®—a simple object oriented language has garbage collection functionality, which greatly simplifies the management of dynamic storage allocation. A compiler, such as just-in-time (JIT) compiler translates a whole segment of code into a machine code before use. Some programming languages, such as JAVA, are executable on a virtual machine. In this manner, a “virtual machine” is an abstract specification of a processor so that special machine code (called “bytecodes”) may be used to develop programs for execution on the virtual machine. Various emulation techniques are used to implement the abstract processor specification including, but not restricted to, interpretation of the bytecodes or translation of the bytecodes into equivalent instruction sequences for an actual processor.

For example, in a managed runtime approach JAVA may be used on advanced low-power, high performance and scalable processor, such as Intel® XScale™ microarchitecture core. In most microarchitectures, when instructions are executed in-order stalls occur in pipelines when data inputs are not ready or resources are not available. These kinds of stalls could dominate a significant part of the execution time, sometime more than 20% on some microprocessors like XScale™.

A number of instruction scheduling techniques are widely adopted in compilers and micro-architectures to reduce the pipeline stalls and improve the efficiency of a central processing unit (CPU). For instance, list scheduling is widely used in compilers for instruction scheduling. This list scheduling generally depends on a data dependency Direct Acyclic Graph (DAG) of instructions. However, multiple heuristic rules could be applied to the DAG to re-arrange the nodes (instructions) to get the minimum execution cycles. Unfortunately, this is a non-polynomial time solvable (NP) problem and all heuristic rules are approximate approaches to the object. In general, a register scoreboard could be used in these architectures to determine the data dependency between instructions. When using instructions from XScale™ assembly codes, on XScale™ architectures, the pipelines would be stalled when the next instruction has data dependency with previous un-finished ones.

Thus, there is a continuing need for better ways to schedule instructions in execution environments for programs written for virtual machines.

### BRIEF DESCRIPTION OF THE DRAWINGS

FIG. 1 is a schematic depiction of a system consistent with one embodiment of the present invention;

FIG. 2 is a schematic depiction of an operating system platform for system 10 of FIG. 1 according to one embodiment of the present invention;

FIG. 3 is a flow chart showing instruction scheduling according to one embodiment of the present invention;

FIG. 4 is a depiction of instructions in accordance with one embodiment of the present invention;

FIG. 5 is a hypothetical register showing a register scoreboard data for instructions shown in FIG. 4 according to one embodiment of the present invention;

FIG. 6 is a hypothetical pseudo code showing a heuristic rule for instruction scheduling of instructions shown in FIG. 4 in accordance with one embodiment of the present invention; and

FIG. 7 is a processor-based system with the operating system platform of FIG. 2 that uses extended register scoreboarding technique for instruction scheduling according to one embodiment of the present invention.

### DETAILED DESCRIPTION

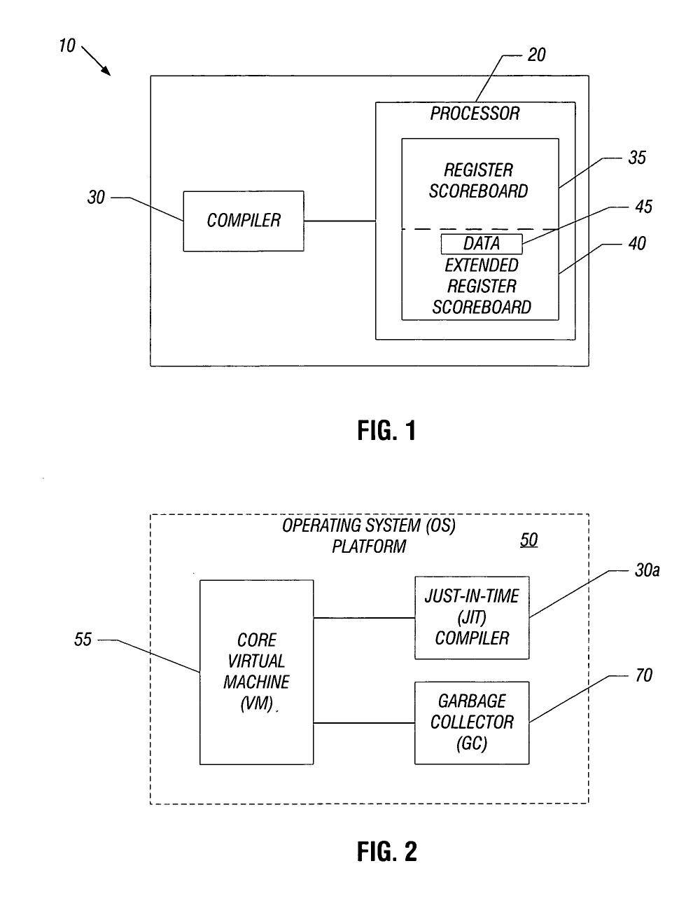

Referring to FIG. 1, a system 10 according to one embodiment of the invention is shown. The system 10 when scheduling instructions may use maximum possible pipeline stall cycles between two instructions instead of a true-or-false boolean value for every two instructions. The system 10 includes a processor 20 and a compiler 30. In one embodiment, compiler 30 is a computer program on a computer (i.e., a compiler program) that resides on a secondary storage medium (e.g., a hard drive on a computer) and is executed on the processor 20.

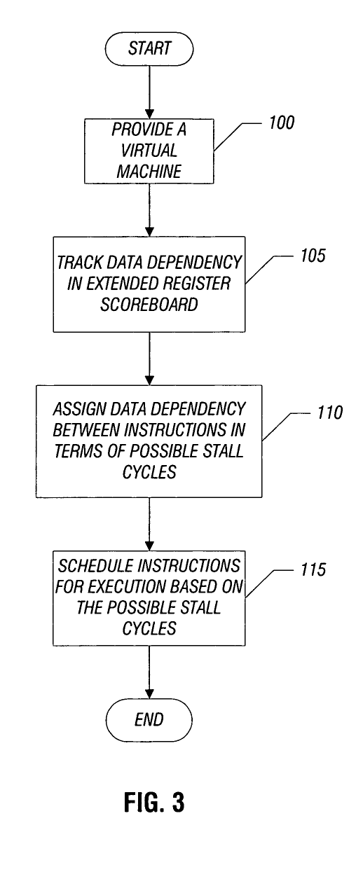

In one embodiment, system 10 may be any processor-based system. Examples of the system 10 include a personal computer (PC), a hand held device, a cell phone, a personal digital assistant, and a wireless device. Those of ordinary skill in the art will appreciate that system 10 may also include other components, not shown in FIG. 3.

The processor 20 may comprise a number of registers including a register scoreboard 35 and an extended register scoreboard 40. The register scoreboard 35 and the extended register scoreboard 40 store dependency data 45 between instructions. For example, dependency data 45 may indicate possible stall cycles in a pipeline of instructions that need scheduling for execution.

A source program is inputted to the processor 20, thereby causing compiler 30 to generate an executable program, as is well-known in the art. Those skilled in the art will appreciate that the embodiments of the present invention are not limited to any particular type of source program, as the type of computer programming languages used to write the source program may vary from procedural code type languages to object oriented languages. In one embodiment, the executable program is a set of assembly code instructions, as is well-known in the art.

Referring to FIG. 2, an operating system (OS) platform 50 may comprise a core virtual machine (VM) 55, a just-in-time (JIT) compiler 30a and a garbage collector (GC) 70. The core virtual machine 55 is responsible for the overall coordination of the activities of the operating system (OS) platform 50. The operating system platform 50 may be a high-performance managed runtime environment (MRTE). The just-in-time compiler 30a may be responsible for compiling bytecodes into native managed code, and for providing information about stack frames that can be used to do root-set enumeration, exception propagation, and security checks.

The main responsibility of the garbage collector 70 may be to allocate space for objects, manage the heap, and perform garbage collection. A garbage collector interface may define how the garbage collector 70 interacts with the core virtual machine 55 and the just-in-time compiler 30a. The managed runtime environment may feature exact generational garbage collection, fast thread synchronization, and multiple just-in-time compilers (JITs), including highly optimizing JITs.

The core virtual machine 55 may further be responsible for class loading: it stores information about every class, field, and method loaded. The class data structure may include the virtual-method table (vtable) for the class (which is shared by all instances of that class), attributes of the class (public, final, abstract, the element type for an array class, etc.), information about inner classes, references to static initializers, and references to finalizers. The operating system platform 50 may allow many JITs to coexist within it. Each JIT may interact with the core virtual machine 55 through a JIT interface, providing an implementation of the JIT side of this interface.

In operation, conventionally when the core virtual machine 55 loads a class, new and overridden methods are not immediately compiled. Instead, the core virtual machine 55 initializes the vtable entry for each of these methods to point to a small custom stub that causes the method to be compiled upon its first invocation. After the JIT compiler 30a compiles the method, the core virtual machine 55 iterates over all vtables containing an entry for that method, and it replaces the pointer to the original stub with a pointer to the newly compiled code.

Referring to FIG. 3, instruction scheduling according to one embodiment of the present invention is shown. At block 100, a virtual machine, such as the core virtual machine 55 shown in FIG. 2 may be provided. For example, consistent with one embodiment of the present invention, a Java Virtual Machine (JVM) is provided to interpretatively execute a high-level, byte-encoded representation of a program in a dynamic runtime environment. In one embodiment, the core virtual machine 55 may schedule instructions. In addition, the garbage collector 70 shown in FIG. 2 may provide automatic management of the address space by seeking out inaccessible regions of that space (i.e., no address points to them) and returning them to the free memory pool. The just-in-time compiler 30a shown in FIG. 2 may be used at runtime or install time to translate the bytecode representation of the program into native machine instructions, which run much faster than interpreted code.

At block 105, the extended register scoreboard 40 and the register scoreboard 35 may be employed to track dependency data 45 between instructions. At block 110, data dependency between instructions in terms of a number of stall cycles may be assigned. In one embodiment, assigned stall cycles are the number of instruction cycles that a first instruction may be delayed because of data dependency on a second instruction. At block 115, the instructions may be scheduled for execution based on the assigned stall cycles. In one embodiment, maximum possible pipeline stall cycles between a first and a second instruction may be used. In this manner, by extending the register scoreboard 35 using the extended register scoreboard 40 to maintain more dependency data 45 than included in the register scoreboard 35 between two instructions, the data dependency may be tracked between a first and a second instruction in terms of possible stall cycles.

In one embodiment, a count of issue latency for the first and second instructions may be maintained in the extended register scoreboard 40. The issue latency is the number of cycles between start of two adjacent instructions. Likewise, a count for the number of cycles from start to end of the issue of the first and second instructions may be maintained. In addition, a count for pipeline stalls between the first and a previous instruction may be maintained.

Consistent with one embodiment, the register scoreboard 35 may be extended by m rows and m columns to keep track of the maximum possible pipeline stall cycles. By keeping track of the first non-zero value from right to left in the m-th row of the register scoreboard 35, the first instruction may be reordered during instruction scheduling. Likewise, by keeping track of the first non-zero value from top to bottom in the m-th column of the register scoreboard 35, the first instruction may be reordered. The extended register scoreboard 40 may further keep track of an instruction that causes pipeline stall.

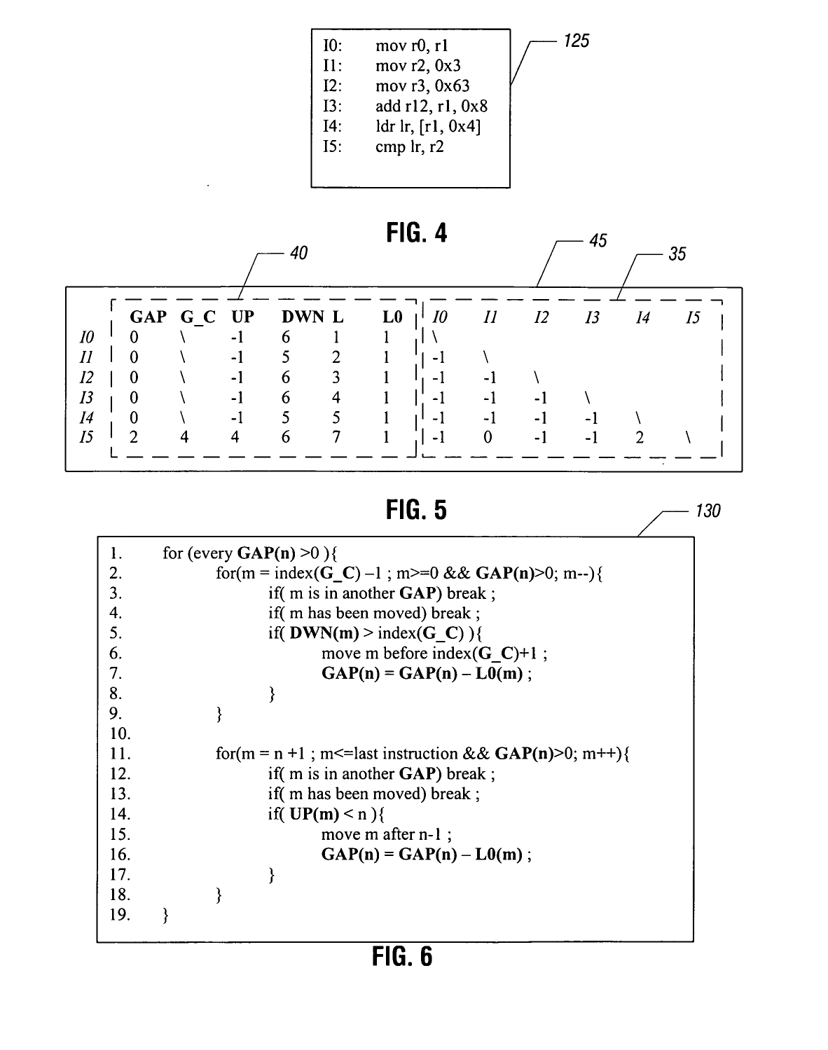

FIG. 4 is a schematic depiction of instructions 125 in accordance with one embodiment of the present invention. The instructions 125 include five separate instructions from I0 to I5, all of which are shown as assembly language instructions that can be executed by the processor 20 of system 10 shown in FIG. 1. First instruction I0 indicates a move instruction that moves contents from register r02 to register r1. Likewise, instruction I1 indicates moving content of register r02 into another location. In this manner, five exemplary instructions as code are shown for scheduling in accordance with one embodiment of the present invention.

FIG. 5 shows a hypothetical data in the register scoreboard 35 and the extended register scoreboard 40 for scheduling instructions 125 shown in FIG. 4 according to one embodiment of the present invention. The dependency data 45 in the extended register scoreboard 40 and the register scoreboard 35 is shown in FIG. 5 for the code piece in FIG. 4. The extended register scoreboard 40 and the register scoreboard 35 use data-dependency-stall number (DDSN) I_{m,n} (where m is the m-th instruction and n is the n-th one) instead of true-or-false boolean value for every two instructions. In one embodiment, the DDSNs are the maximum possible pipeline stall cycles between two instructions. In the extended register scoreboard 40 and the register scoreboard 35, a negative number “−1” stands for no data dependency between two instructions.

In FIG. 5, the column L0 stands for issue latency of every instruction. The column L stands for the cycles from start to the end of the issue of every instruction. The cycles from start to the end of the issue may be computed with formula: L(m)=L(m−1)+L0(m)+max{[I_{m,0}−(L(m−1)−L(0))], . . . , [I_{m,k}−(L(m−1)−L(k)), . . . , (I_{m,m-1})]}. (Here I_{m,0} is the possible dependency stall number between the i-th instruction and the first one I₀). The column GAP stands for the pipeline stalls between a first instruction and the previous instruction. The column GAP equals to max {L(i)−L(i−1)−L0(i)}, 0≦i<m. The column UP(m) equals to the index (where index is the instruction index in the code piece) of the first non-zero value from right to left in the m-th row of DDSN. The column DWN(m) equals to the index (where index is the instruction index in the code piece) of the first non-zero value from top to down in the m-th column of DDSN. These two columns UP(m) and DWN(m) indicate the “movable range” of an instruction. That means, an instruction could be safely re-ordered in this range without violating the data dependency. The column G_C stands for “Gap Ceil” that indicates which instruction causes this gap between a first instruction and the previous instruction, or in other words, the pipeline stall.

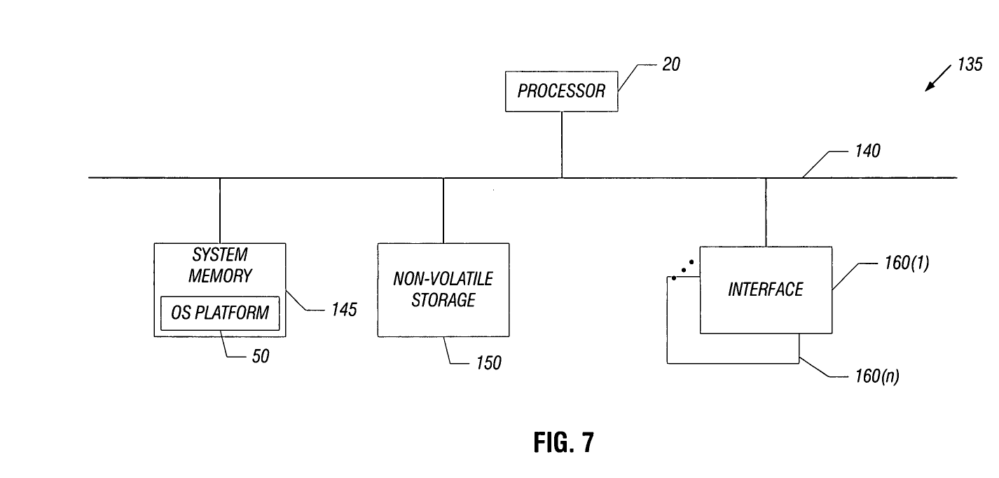

FIG. 6 is a hypothetical pseudo code 130 showing a heuristic rule for scheduling instructions 125 shown in FIG. 4 in accordance with one embodiment of the present invention. If the GAPs of all instructions are zeros, there is no need to schedule the instructions, as in-order execution is just the most efficient way. If any non-zero GAP exists, however, a simple heuristic rule in FIG. 7 with linear complexity of order O(n) may eliminate most of GAPs in many Java applications.

In FIG. 6, for every non-zero GAP, the first loop (code lines 2˜9) searches the previous instructions before G_C of this GAP, until the GAP has been fully filled. If the current instruction is encapsulated by another GAP (code line 3), or it has been moved before (code line 4), the loop will break. If DWN of the current instruction is larger than G_C, the current instruction will be moved before the next instruction after G_C (code line 6). The L0 of the moved instruction will be subtracted from GAP (code line 7).

The second loop (code lines 11˜18) searches the instructions behind the current GAP. The loop and break conditions (code lines 11, 12, 13) are similar to the aforementioned loop. The UP instead of DWN is used in the condition at code line 14. And the movable instructions are moved after the instruction before GAP (code line 15). All instructions in a code block are searched at most twice and there is no need to update any information except non-zero GAPs. Hence, the complexity of this heuristic rule is linear.

FIG. 7 shows a processor-based system 135 that includes the operating system platform 50 of FIG. 2 and uses extended register scoreboarding technique for instruction scheduling according to one embodiment of the present invention. The processor-based system 135 may include the processor 20 shown in FIG. 1 according to one embodiment of the present invention. The processor 20 may be coupled to a system memory 145 storing the OS platform 50 via a system bus 140. The system bus 140 may couple to a non-volatile storage 150. Interfaces 160 (1) through 160(n) may couple to the system bus 140 in accordance with one embodiment of the present invention. The interface 160 (1) may be a bridge or another bus based on the processor-based system 135 architecture.

For example, depending upon the OS platform 50, the processor-based system 135 may be a mobile or a wireless device. In this manner, the processor-based system 135 uses a technique that includes providing a virtual machine for instruction scheduling by extending a register scoreboard in execution environments for programs written for virtual machines. In one embodiment, the non-volatile storage 150 may store instructions to use the above-described technique. The processor 20 may execute at least some of the instructions to provide the core virtual machine 55 that assigns a number of stall cycles between a first and a second instruction and schedules said first and second instructions for execution based on the assigned stall cycles.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
assigning a number of stall cycles between a first and a second instruction; and
scheduling said first and second instructions for execution based on the assigned stall cycles.

2. The method of claim 1, further comprising:
using a number of maximum possible pipeline stall cycles between said first and second instructions to indicate a data dependency therebetween.

3. The method of claim 2, further comprising:
extending a register scoreboard that keeps track of the data dependency.

4. The method of claim 3, further comprising:
maintaining a count of issue latency for said first and second instructions.

5. The method of claim 3, further comprising:
maintaining a count for a number of cycles from start to end of a issue of said first and second instructions.

6. The method of claim 3, further comprising:
maintaining a count for pipeline stalls between said first instruction and a previous instruction.

7. The method of claim 3, further comprising:
extending the register scoreboard by m rows and m columns to keep track of a maximum possible pipeline stall cycles.

8. The method of claim 7, further comprising:
keeping track of a first non-zero value from right to left in an m-th row of the register scoreboard to reorder said first instruction.

9. The method of claim 7, further comprising:
keeping track of a first non-zero value from top to bottom in an m-th column of the register scoreboard to reorder said first instruction.

10. The method of claim 3, further comprising:
keeping track of an instruction that causes pipeline stall.

11. An apparatus comprising:
a register to store a number of stall cycles between a first and a second instruction; and
a compiler coupled to schedule said first and second instructions for execution based on the stall cycles.

12. The apparatus of claim 11, wherein said compiler uses a number of maximum possible pipeline stall cycles between said first and second instructions to indicate data dependency therebetween.

13. The apparatus of claim 12, wherein said register is extended by m-rows and m-columns to keep track of maximum possible pipeline stall cycles.

14. The apparatus of claim 13, wherein said compiler to keep track of a first non-zero value from right to left in m-th row to reorder said first instruction.

15. The apparatus of claim 13, wherein said compiler to keep track of a first non-zero value from top to bottom in the m-th column to reorder the first instruction.

16. A system comprising:
a non-volatile storage storing instructions;
a processor to execute at least some of the instructions to provide a virtual machine that assigns a number of stall cycles between a first and a second instruction and
schedules said first and second instructions for execution based on the assigned stall cycles.

17. The system of claim 16, further comprising:
a register to store dependency data between said first and second instructions.

18. The system of claim 17, further comprising:
a compiler coupled to schedule said first and second instructions for execution based on a maximum possible pipeline stall cycles.

19. The system of claim 16, wherein said register is a register scoreboard.

20. The system of claim 17, wherein said compiler is just-in-time compiler for an object-oriented programming language.

21. An article comprising a computer readable storage medium storing instructions that, when executed cause a processor-based system to:
assign a number of stall cycles between a first and a second instruction; and
schedule said first and second instructions for execution based on the assigned stall cycles.

22. The article of claim 21, comprising a medium storing instructions that, when executed cause a processor-based system to:
use the number of maximum possible pipeline stall cycles between said first and second instructions to indicate the data dependency therebetween.

23. The article of claim 22, comprising a medium storing instructions that, when executed cause a processor-based system to:
extend a register scoreboard that keeps track of the data dependency.

24. The article of claim 23, comprising a medium storing instructions that, when executed cause a processor-based system to:
maintain a count of issue latency for said first and second instructions.

25. The article of claim 23, comprising a medium storing instructions that, when executed cause a processor-based system to:
maintain a count for the number of cycles from start to end of the issue of said first and second instructions.

26. The article of claim 23, comprising a medium storing instructions that, when executed cause a processor-based system to:
maintain a count for pipeline stalls between said first instruction and a previous instruction.

27. The article of claim 23, comprising a medium storing instructions that, when executed cause a processor-based system to:
extend the register scoreboard by m rows and m columns to keep track of the maximum possible pipeline stall cycles.

28. The article of claim 27, comprising a medium storing instructions that, when executed cause a processor-based system to:
keep track of the first non-zero value from right to left in the m-th row of the register scoreboard to reorder said first instruction.

29. The article of claim 27, comprising a medium storing instructions that, when executed cause a processor-based system to:
keep track of the first non-zero value from top to bottom in the m-th column of the register scoreboard to reorder said first instruction.

30. The article of claim 23, comprising a medium storing instructions that, when executed cause a processor-based system to:
keep track of an instruction that causes pipeline stall.
